(19) United States
(12) Patent Application Publication
(10) Pub. No.: US 2022/0037659 A1
(43) Pub. Date: Feb. 3, 2022

(54) ALL SOLID STATE BATTERY

(71) Applicants: Hideaki Nishimura, Shizuoka-ken (JP); Yohei Shindo, Toyota-shi (JP); Masaru Kuboto, Okazaki-shi (JP); So Yubuchi, Susono-shi (JP); Hitomi Nakamura, Niihama-shi (JP); Ryousuke Okamoto, Niihama-shi (JP); Kazuhide Hayashi, Niihama-shi (JP); Mikako Touma, Niihama-shi (JP)

(72) Inventors: Hideaki Nishimura, Shizuoka-ken (JP); Yohei Shindo, Toyota-shi (JP); Masaru Kuboto, Okazaki-shi (JP); So Yubuchi, Susono-shi (JP); Hitomi Nakamura, Niihama-shi (JP); Ryousuke Okamoto, Niihama-shi (JP); Kazuhide Hayashi, Niihama-shi (JP); Mikako Touma, Niihama-shi (JP)

(73) Assignees: Toyota Jidosha Kabushiki Kaisha, Toyota-shi Aichi-ken (JP); Sumitomo Metal Mining Co., Ltd., Tokyo (JP)

(21) Appl. No.: 17/382,978

(22) Filed: Jul. 22, 2021

(30) Foreign Application Priority Data
Jul. 30, 2020 (JP) 2020-129077

(51) Int. Cl. H01M 4/525; H01M 10/0562

(52) U.S. Cl. CPC H01M 4/525; H01M 2004/028; H01M 10/0562

(57) ABSTRACT

A main object of the present disclosure is to provide an all solid state battery with good capacity property. The present disclosure achieves the object by providing an all solid state battery comprising a cathode layer including a composite cathode active material, an anode layer, and a solid electrolyte layer formed between the cathode layer and the anode layer, and the composite cathode active material includes a cathode active material represented by LiₐNiₓCo_{y}Al_{z}Nb_{b}O₂ wherein 1.0≤a≤1.05, x+y+z+b=1, 0.8≤x≤0.83, 0.13≤y≤0.15, 0.03≤z≤0.04, 0<b≤0.011; and a coating layer covering at least a part of a surface of the cathode active material and including an ion conductive oxide, and at least one of the cathode layer and the solid electrolyte layer includes a sulfide solid electrolyte.

### CROSS-REFERENCE TO RELATED APPLICATION

This application claims priority to Japanese Patent Application No. 2020-129077 filed on Jul. 30, 2020, incorporated herein by reference in its entirety.

### TECHNICAL FIELD

The present disclosure relates to an all solid state battery.

### BACKGROUND ART

An all solid state battery is a battery including a solid electrolyte layer between a cathode layer and an anode layer, and has advantages in that it is easy to simplify a safety device as compared with a liquid battery including a liquid electrolyte containing flammable organic solvents.

Although it is not a technique relating an all solid state battery, Patent Literature 1 discloses that, in a liquid battery, a cathode for a lithium ion battery includes a lithium-nickel metal composite oxide powder represented by LiₐNi_{1-x-y}CoₓM_{y}O_{b} wherein 0.9<a<1.0, 1.7<b<2.0, 0.01<x≤0.15, and 0.005<y<0.10, “M” includes an Al element, and is a metal element that may further include one or more element selected from Mn, W, Nb, Mg, Zr, and Zn.

### CITATION LIST

### Patent Literature

Patent Literature 1: Japanese Patent Application Laid-Open (JP-A) No. 2018-118891

### SUMMARY

### Technical Problem

The all solid state battery is required to have good capacity property. The present disclosure has been made in view of the above circumstances, and a main object thereof is to provide an all solid state battery with good capacity property.

### Solution to Problem

In order to achieve the object, the present disclosure provides an all solid state battery comprising a cathode layer including a composite cathode active material, an anode layer, and a solid electrolyte layer formed between the cathode layer and the anode layer, and the composite cathode active material includes a cathode active material represented by LiₐNiₓCo_{y}Al_{z}Nb_{b}O₂ wherein 1.0≤a≤1.05, x+y+z+b=1, 0.8≤x≤0.83, 0.13≤y≤0.15, 0.03≤z≤0.04, 0<b≤0.011; and a coating layer covering at least a part of a surface of the cathode active material and including an ion conductive oxide, and at least one of the cathode layer and the solid electrolyte layer includes a sulfide solid electrolyte.

According to the present disclosure, an all solid state battery with good capacity property may be obtained by using a composite cathode active material including a cathode active material having a predetermined composition including Nb, and a coating layer.

In the disclosure, the “b” may satisfy 0.004≤b≤0.011.

In the disclosure, the “b” may satisfy 0.006≤b≤0.011.

In the disclosure, the ion conductive oxide may be LiNbO₃.

### Advantageous Effects of Disclosure

The present disclosure exhibits an effect that an all solid state battery with good capacity property may be obtained.

### BRIEF DESCRIPTION OF DRAWINGS

FIG. 1 is a schematic cross-sectional view illustrating an example of an all solid state battery in the present disclosure.

FIG. 2 is a schematic cross-sectional view illustrating an example of a composite cathode active material in the present disclosure.

FIG. 3 is the result of the charge/discharge test in Examples 1 to 3 and Comparative Examples 1 to 4.

### DETAILED DESCRIPTION

An all solid state battery in the present disclosure will be hereinafter described in detail.

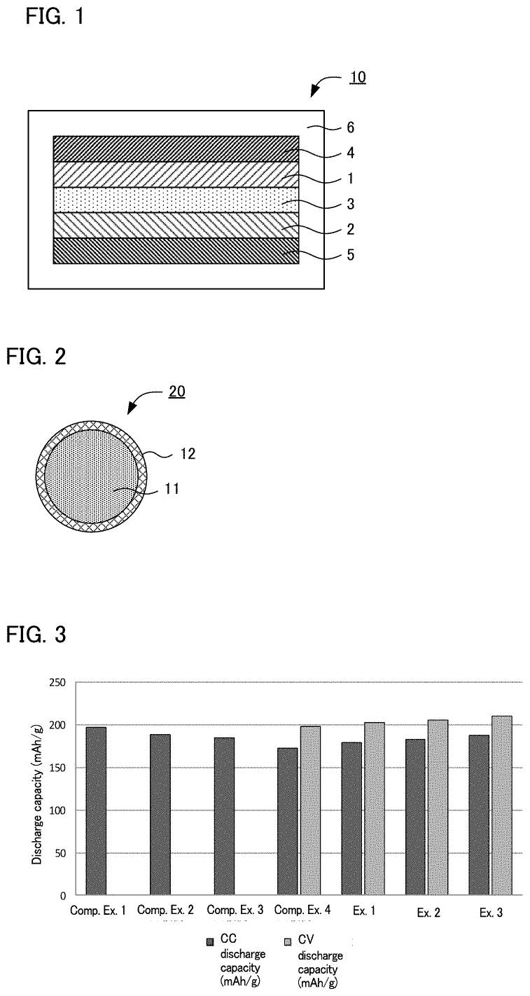

FIG. 1 is a schematic cross-sectional view illustrating an example of an all solid state battery in the present disclosure. Further, FIG. 2 is a schematic cross-sectional view illustrating an example of a composite cathode active material in the present disclosure. As shown in FIG. 1 and FIG. 2, all solid state battery 10 comprises cathode layer 1 including composite cathode active material 20, anode layer 2, solid electrolyte layer 3 formed between cathode layer 1 and anode layer 2, cathode current collector 4 for collecting current of cathode layer 1, anode current collector 5 for collecting current of anode layer 2, and battery case 6 that houses these members. In the present disclosure, composite cathode active material 20 includes cathode active material 11 having a predetermined composition including Nb, and coating layer 12 covering at least a part of a surface of cathode active material 11 and including an ion conductive oxide. Also, at least one of cathode layer 1 and solid electrolyte layer 3 includes a sulfide solid electrolyte.

According to the present disclosure, an all solid state battery with good capacity property may be obtained by using a composite cathode active material including a cathode active material having a predetermined composition including Nb, and a coating layer. As disclosed in the above described Patent Literature 1, in the liquid battery, a cathode active material wherein Nb is added to so-called NCA based active material has been known. Here, as described in Examples below, in the liquid battery, the capacity thereof decreased as the added (substituted) amount of Nb in the cathode active material was higher. The reason therefor is presumed that the amount of the redox transition metal (Ni, Co) was decreased as the added amount of Nb increased. In contrast to this, in the all solid state battery using a sulfide solid electrolyte, it was surprisingly found out that the capacity increases as the added amount of Nb increases. Although the reason why the capacity increases in the all solid state battery is not clear, it is presumed as follows.

In the all solid state battery using the sulfide solid electrolyte, in order to suppress the reaction between an oxide active material and the sulfide solid electrolyte, the formation of a coating layer including an oxide such as lithium niobate, on the surface of the oxide active material is expected. Here, when Nb is included in the cathode active material, the diffusion of Nb into the cathode active material surface is presumed. As the result, it is presumed that the diffused Nb functions as a pseudo LiNbO₃ layer (coating layer), together with nearby existing Li and O, with respect to the part not coated with the coating layer, or the part with a thin coating layer so that the reaction between the oxide active material and the sulfide solid electrolyte may be suppressed. Particularly when the coating layer includes the ion conductive oxide including Nb, the reaction between the oxide active material and the sulfide solid electrolyte may be further suppressed since the affinity between the Nb diffused from the oxide active material (cathode active material) and the ion conductive oxide (an oxide including Nb) included in the coating layer is high. Further, since the cathode active material in the present disclosure has a predetermined composition, the capacity property and the Nb diffusion property are good.

1. Cathode Layer

The cathode layer is a layer including at least a composite cathode active material. Also, the cathode layer may include a sulfide solid electrolyte. Also, the cathode layer may include at least one of a conductive auxiliary material, and a binder, as necessary.

(1) Composite Cathode Active Material

The composite cathode active material in the present disclosure includes a cathode active material and a coating layer. The cathode active material is represented by LiₐNiₓCo_{y}Al_{z}Nb_{b}O₂ wherein 1.0≤a≤1.05, x+y+z+b=1, 0.8≤x≤0.83, 0.13≤y≤0.15, 0.03≤z≤0.04, 0<b≤0.011. The “b” is usually more than 0, may be 0.003 or more, may be 0.004 or more, and may be 0.006 or more. Meanwhile, the “b” is usually 0.011 or less, and may be 0.008 or less. Here, the value of “b” may be referred to as Nb substituted amount. For example, when the “b” is 0.006, the Nb substituted amount is 0.6%.

The cathode active material in the present disclosure may be purchased as a commercially available product, and may be prepared by oneself. The method for preparing the cathode active material oneself is not particularly limited, and conventionally known methods may be used. For example, the cathode active material may be obtained by a method similar to the methods described in JP-A No. 2015-72801 and JP-A 2015-122298.

The coating layer in the present disclosure covers at least a part of a surface of the cathode active material and includes an ion conductive oxide. The proportion of the ion conductive oxide in the coating layer is, for example, 80 weight % or more, may be 90 weight % or more, and may be 95 weight % or more.

Examples of the ion conductive oxide may include an oxide represented by a general formula LiₓAO_{y}, wherein “A” is at least on kind of Nb, B, C, Al, Si, P, S, Ti, Zr, Mo, Ta, and W, and “x” and “y” are positive integers. The ion conductive oxide may include at least Nb as the “A” element. The reason therefor is to further suppress the reaction between the cathode active material and the sulfide solid electrolyte, since the affinity between the Nb diffused from the cathode active material and the ion conductive oxide (an oxide including Nb) included in the coating layer is high. Specific examples of the ion conductive oxide may include LiNbO₃, Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, Li₂MoO₄, and Li₂WO₄.

The coverage of the coating layer is, for example, 70% or more, and may be 80% or more, and may be 90% or more. Meanwhile, the coverage of the coating layer may be 100%, and may be less than 100%. The coverage of the coating layer may be determined by X-ray photoelectron spectroscopy (XPS) measurement. The thickness of the coating layer is, for example, 0.1 nm or more, may be 1 nm, and may be 5 nm or more. Meanwhile, the thickness of the coating layer is, for example, 100 nm or less, may be 50 nm or less, and may be 20 nm or less. The thickness of the coating layer may be determined by, for example, using a transmission electron microscope (TEM).

Examples of the shape of the composite cathode active material may include a granular shape. The average particle size of the composite cathode active material is, for example, 0.05 μm or more, and may be 0.1 μm or more. Meanwhile, the average particle size of the composite cathode active material is, for example, 50 μm or less, and may be 20 μm or less. The average particle size of the composite cathode active material may be defined as D50, and may be calculated from the measurement by, for example, a laser diffraction particle size analyzer, and a scanning electron microscope (SEM).

The method for forming the coating layer is not particularly limited, and conventionally known method such as a sol-gel method may be used. For example, when forming a coating layer including LiNbO₃, examples of the method may include a method wherein a composition is produced by dissolving equal moles of LiOC₂H₅ and Nb(OC₂H₅)₅ into a solvent such as ethanol, the surface of the cathode active material is spray coated with the composition using a rolling fluidized coating device, then, the coated cathode active material is heat treated.

The proportion of the composite cathode active material in the cathode layer is, for example, 20 weight % or more, may be 30 weight % or more, and may be 40 weight % or more. Meanwhile, the proportion of the composite cathode active material is, for example, 80 weight % or less, may be 70 weight % or less, and may be 60 weight % or less.

(2) Solid Electrolyte

The cathode layer may include a solid electrolyte. The ion conductivity in the cathode layer may be improved by using the solid electrolyte. Examples of the solid electrolyte may include an inorganic solid electrolyte such as a sulfide solid electrolyte, an oxide solid electrolyte, a nitride solid electrolyte, and a halide solid electrolyte. Among the above, the cathode layer may include the sulfide solid electrolyte. Particularly, in the cathode layer, the sulfide solid electrolyte may be in contact with the composite cathode active material.

Examples of the sulfide solid electrolyte may include a solid electrolyte containing a Li element, an X element (X is at least one kind of P, As, Sb, Si, Ge, Sn, B, Al, Ga, and In), and a S element. Also, the sulfide solid electrolyte may further include at least one of an O element and a halogen element. Examples of the halogen element may include a F element, a Cl element, a Br element, and an I element.

The sulfide solid electrolyte may include an anion structure of an ortho composition (PS₄³⁻ structure, SiS₄⁴⁻ structure, GeS₄⁴⁻ structure, AlS₃³⁻ structure, and BS₃³⁻ structure) as the main component of the anion. The reason therefor is to allow a high chemical stability. The proportion of the anion structure of an ortho composition to all the anion structures in the sulfide solid electrolyte is, for example, 70 mol % or more, and may be 90 mol % or more. The proportion of the anion structure of an ortho composition may be determined by, for example, a Raman spectroscopy, NMR, and XPS. Specific examples of the sulfide solid electrolyte may include xLi₂S.(100−x)P₂S₅ (70≤x≤80), and yLiI.zLiBr.(100−y−z)Li₃PS₄) (0≤y≤30, and 0≤z≤30).

The sulfide solid electrolyte may be a glass based sulfide solid electrolyte, and may be a glass ceramic based sulfide solid electrolyte. The glass based sulfide solid electrolyte may be obtained by vitrifying raw material. The glass ceramic based sulfide solid electrolyte may be obtained by, for example, heat treating the above described glass based sulfide solid electrolyte. Also, the sulfide solid electrolyte may include a predetermined crystal structure. Examples of the crystal structure may include a Thio-LISICON type crystal structure, a LGPS type crystal structure, and an argyrodite type crystal structure.

Examples of the shape of the solid electrolyte may include a granular shape. The average particle size of the solid electrolyte is, for example, 0.05 μm or more, and may be 0.1 μm or more. Meanwhile, the average particle size of the solid electrolyte is, for example, 50 μm or less, and may be 20 μm or less. The average particle size of the solid electrolyte may be defined as D50, and may be calculated from the measurement by, for example, a laser diffraction particle size analyzer, and a scanning electron microscope (SEM).

The proportion of the solid electrolyte in the cathode layer is, for example, 1 weight % or more, may be 10 weight % or more, and may be 20 weight % or more. Meanwhile, the proportion of the solid electrolyte is, for example, 60 weight % or less, and may be 50 weight % or less.

(3) Others

The cathode layer may include a conductive auxiliary material. The electron conductivity in the cathode layer may be improved by using the conductive auxiliary material. Examples of the conductive auxiliary material may include a carbon material, a metal particle, and a conductive polymer. Examples of the carbon material may include a granular carbon materials such as acetylene black (AB) and Ketjen black (KB); and a fibrous carbon materials such as carbon fiber, carbon nanotube (CNT), and carbon nanofiber (CNF).

Also, the cathode layer may include a binder. The denseness of the cathode layer may be improved by using the binder. Examples of the binder may include rubber based binders such as butylene rubber (BR) and styrene butadiene rubber (SBR); and fluoride based binders such as polyvinylidene fluoride (PVDF) and polytetrafluoroethylene (PTFE). The thickness of the cathode layer is, for example, 0.1 μm or more and 1000 μm or less.

2. Anode Layer

The anode layer is a layer including at least an anode active material. Also, the anode layer may include at least one of a solid electrolyte, a conductive auxiliary material, and a binder, as necessary.

The anode active material is not particularly limited, and examples thereof may include a metal active material, a carbon active material, and an oxide active material. Examples of the metal active material may include a simple substance of a metal, and a metal alloy. Examples of the metal element included in the metal active material may include Si, Sn, In, and Al. The metal alloy may be an alloy including the above described metal element as a main component.

Meanwhile, examples of the carbon active material may include mesocarbon microbeads (MCMB), highly oriented pyrolytic graphite (HOPG), hard carbon, and soft carbon. Also, examples of the oxide active material may include lithium titanate such as Li₄Ti₅O₁₂.

The proportion of the anode active material in the anode layer is, for example, 20 weight % or more, may be 30 weight % or more, and may be 40 weight % or more. Meanwhile, the proportion of the anode active material is, for example, 80 weight % or less, may be 70 weight % or less, and may be 60 weight % or less.

The solid electrolyte, the conductive auxiliary material and the binder may be similar to those described in “1. Cathode layer” above; thus, the descriptions herein are omitted. The thickness of the anode layer is, for example, 0.1 μm or more and 1000 μm or less.

3. Solid Electrolyte Layer

The solid electrolyte layer is a layer formed between the cathode layer and the anode layer, and is a layer including at least a solid electrolyte. Also, the solid electrolyte layer may include the solid electrolyte only, and may further include a binder.

The solid electrolyte layer may include a sulfide solid electrolyte as the solid electrolyte. Particularly, the sulfide solid electrolyte included in the solid electrolyte layer may be in contact with the composite cathode active material included in the cathode layer. The sulfide solid electrolyte, and the binder may be similar to those described in “1. Cathode layer” above; thus, the descriptions herein are omitted. The thickness of the solid electrolyte layer is, for example, 0.1 μm or more and 1000 μm or less.

4. Other Constitutions

The battery in the present disclosure may comprise a cathode current collector for collecting currents of the cathode layer and an anode current collector for collecting currents of the anode layer. Examples of the materials for the cathode current collector may include SUS, aluminum, nickel, iron, titanium, and carbon. Meanwhile, examples of the materials for the anode current collector may include SUS, copper, nickel, and carbon.

The all solid state battery in the present disclosure may further include a confining jig that applies a confining pressure along the thickness direction, to the cathode layer, the solid electrolyte layer and the anode layer. The confining pressure is, for example, 0.1 MPa or more, may be 1 MPa or more, and may be 5 MPa or more. Meanwhile, the confining pressure is, for example, 100 MPa or less, may be 50 MPa or less, and may be 20 MPa or less.

5. All Solid State Battery

The kind of the all solid state battery in the present disclosure is not particularly limited; and is typically a lithium ion battery. Also, the all solid state battery in the present disclosure may be a primary battery and may be a secondary battery; above all, the secondary battery so as to be repeatedly charged and discharged, and be useful as a car-mounted battery, for example.

The all solid state battery in the present disclosure may be a single cell battery and may be a stacked battery. The stacked battery may be a monopolar type stacked battery (a stacked battery connected in parallel), and may be a bipolar type stacked battery (a stacked battery connected in series). Examples of the shape of the battery may include a coin shape, a laminate shape, a cylindrical shape, and a square shape.

Incidentally, the present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### EXAMPLES

### Example 1

<Production of Composite Cathode Active Material>

As a cathode active material, Li_{1.03}Ni_{0.813}Co_{0.149}Al_{0.034}Nb_{0.004}O₂ (Nb substituted amount of 0.4%) was prepared, and the surface of the cathode active material was coated with lithium niobate (LiNbO₃) to produce a composite cathode active material. The coating with the lithium niobate was carried out as described below. Equal moles of LiOC₂H₅ and Nb(OC₂H₅)₅ were dissolved into ethanol solvent to produce a composition. This composition was spray coated on the surface of the cathode active material by using a rolling fluidized coating device (SFP-01, from by Pawrex Corp.). After that, the surface of the cathode active material was coated with LiNbO₃ by heat treating the coated cathode active material at 350° C. under atmospheric pressure for one hour.

<Production of Cathode>

A butyl butyrate, a butyl butyrate solution containing a PVDF based binder (from Kureha Co., Ltd.) at the ratio of 5 weight %, the above composite cathode active material, a sulfide solid electrolyte (average particle size: 0.8 μm, Li₂S—P₂S₅ based glass ceramic including LiI and LiBr) and VGCF (from Showa Denko Co., Ltd.) as a conductive auxiliary material were added to a polypropylene container, stirred for 30 seconds with an ultrasonic dispersion apparatus (UH-50, from SMT Corp.). Next, the container was shaken with a shaker (TTM-1, from Sibata Scientific Technology LTD.) for 3 minutes, further, stirred for 30 seconds with the ultrasonic dispersion apparatus. Then, a cathode mixture was produced by shaking the container with the shaker for 3 minutes. The cathode mixture was pasted on an aluminum foil (from Nippon Foil Mfg. Co., Ltd.) by a blade method using an applicator. After naturally drying, it was dried for 30 minutes on a hot plate adjusted to be 100° C., thereby obtaining a cathode including a cathode layer on the aluminum foil (cathode current collector).

<Production of Anode>

A butyl butyrate, a butyl butyrate solution containing a PVDF based binder (from Kureha Co., Ltd.) at the ratio of 5 weight %, an anode active material (lithium titanate particle, from Ube Industries, Ltd.), and the above described sulfide solid electrolyte were added to a polypropylene container, stirred for 30 seconds with an ultrasonic dispersion apparatus (UH-50, from SMT Corp.). Next, the container was shaken with a shaker (TTM-1, from Sibata Scientific Technology LTD.) for 30 minutes, further, stirred for 30 seconds with the ultrasonic dispersion apparatus. Then, an anode mixture was produced by shaking the container with the shaker for 3 minutes. The anode mixture was pasted on a copper foil by a blade method using an applicator. After naturally drying, it was dried for 30 minutes on a hot plate adjusted to be 100° C., thereby obtaining an anode including an anode layer on the copper foil (anode current collector).

<Production of Solid Electrolyte Layer>

A heptane, a heptane solution containing a BR based binder (from JSR Corporation) at the ratio of 5 weight %, and a sulfide solid electrolyte (average particle size: 2.5 μm, Li₂S—P₂S₅ based glass ceramic including LiI and LiBr) were added to a polypropylene container, stirred for 30 seconds with an ultrasonic dispersion apparatus (UH-50, from SMT Corp.). Next, the container was shaken with a shaker (TTM-1, from Sibata Scientific Technology LTD.) for 30 minutes, further, stirred for 30 seconds with the ultrasonic dispersion apparatus. Then, a slurry was produced by shaking the container with the shaker for 3 minutes. The slurry was pasted on an aluminum foil by a blade method using an applicator. After naturally drying, it was dried for 30 minutes on a hot plate adjusted to be 100° C., thereby forming a solid electrolyte layer on the aluminum foil as a substrate.

<Production of all Solid State Battery>

An anode punched into a circle of 1.08 cm², and a solid electrolyte layer similarly punched into a circle of 1.08 cm² were pasted together so as the anode layer and the solid electrolyte layer were in direct contact with each other, and pressed under 6 t/cm². After that, the aluminum foil as a substrate was peeled off. Then, a cathode punched into a circle of 1 cm² was pasted so that the cathode layer and the solid electrolyte layer were in direct contact with each other, and pressed under 6 t/cm². As described above, a unit cell including the solid electrolyte layer formed between the cathode layer and the anode layer was produced. A battery (all solid state battery) was produced by stacking the above, and housing thereof in a battery case (a laminate of aluminum and resin film).

### Example 2

A composite cathode active material and a battery were produced in the same manner as in Example 1 except that Li_{1.04}Ni_{0.811}Co_{0.149}Al_{0.034}Nb_{0.006}O₂ (Nb substituted amount of 0.6%) was used as the cathode active material.

### Example 3

A composite cathode active material and a battery were produced in the same manner as in Example 1 except that Li_{1.04}Ni_{0.806}Co_{0.149}Al_{0.034}Nb_{0.011}O₂ (Nb substituted amount of 1.1%) was used as the cathode active material.

### Comparative Example 1

<Production of Electrode>

As a cathode active material, Li_{1.03}Ni_{0.816}Co_{0.15}Al_{0.034}O₂ (Nb substituted amount of 0%) was prepared. This cathode active material, PVDF based binder (from Kureha Co., Ltd.), and a conductive auxiliary material (HS-100, from Denka Co., Ltd.) were weighed so as the solid component weight ratio is 85:10:5, and mixed in a mortar for 5 minutes. After that, the above was added into a container together with a solvent (N-methyl-2-pyrrolidone: NMP) of 50% of the cathode active material weight, and was mixed in a mixing and kneading device (from Thinky Corporation) for 10 minutes at 2000 rpm. Then, further 32% of the active material weight of NMP was added to the container, and was mixed in a mixing and kneading device (from Thinky Corporation) for 10 minutes at 2000 rpm to obtain a slurry. The slurry was dropped onto an Al foil, and applied with a 150 μm doctor blade. After the application, it was dried in an electric furnace at 100° C. for 30 minutes to produce an electrode (cathode).

<Production of Coin Shaped Battery>

The electrode was punched so as to be φ16, sandwiched between Al foils, and pressed. The pressed electrode was dried in a vacuum drier at 120° C. for 8 hours. Also, in a glove box, a Li foil was drawn with a roller, and punched so as to be φ19. Then, the Li foil was placed on an anode can of 2032 k type, one drop of a liquid electrolyte (from Mitsubishi Chemical Corporation) was added, a separator (UP3074, from Ube Industries, LTD.) punched so as to be φ19 was placed thereon, and a packing was installed. One drop of the liquid electrolyte was added thereto, the electrode was placed, a SUS spacer, and a SUS washer were placed in this order, and a cathode can was installed. Then, the above was pressed for 3 seconds with a coin presser to produce a coin shaped battery (liquid based battery).

### Comparative Example 2

A coin shaped battery was produced in the same manner as in Comparative Example 1 except that Li_{1.04}Ni_{0.811}Co_{0.149}Al_{0.034}Nb_{0.006}O₂ (Nb substituted amount of 0.6%) was used as the cathode active material.

### Comparative Example 3

A coin shaped battery was produced in the same manner as in Comparative Example 1 except that Li_{1.04}Ni_{0.806}Co_{0.149}Al_{0.034}Nb_{0.011}O₂ (Nb substituted amount of 1.1%) was used as the cathode active material.

### Comparative Example 4

A composite cathode active material and an all solid state battery were produced in the same manner as in Example 1 except that Li_{1.03}Ni_{0.816}Co_{0.15}Al_{0.034}O₂ (Nb substituted amount of 0%) was used as the cathode active material.

[Evaluation]

<Charge/Discharge Test>

A CCCV charge/discharge test was carried out for the batteries produced in Examples 1 to 3 and Comparative Example 4 in a voltage range of 1.5 V to 2.8 V at current rate of 1/10 C, and stop condition of 1/100 C. The capacity was evaluated by dividing the initial discharge capacity (mAh) between 2.8 V and 1.5 V by the weight (g) of the cathode active material. Also, CC charge/discharge test was carried out for the batteries produced in Comparative Examples 1 to 3 in a voltage range of 3 V to 4.3 V at current rate of 1/10 C. The capacity was evaluated by dividing the initial discharge capacity (mAh) between 4.3 V and 3 V by the weight (g) of the cathode active material. The results are shown in Table 1 and FIG. 3. Incidentally, both of CC discharge capacity and CV discharge capacity were determined in Examples 1 to 3 and Comparative Example 4, and only CC discharge capacity was determined in Comparative Examples 1 to 3.

TABLE 1

| | Nb | | CC | CV |
|---|---|---|---|---|
| | substituted | | discharge | discharge |
| | amount | | capacity | capacity |
| | (% in metal) | Kind of electrolyte | (mAh/g) | (mAh/g) |
| Comp. Ex. 1 | 0 | Liquid electrolyte | 197 | — |
| Comp. Ex. 2 | 0.6 | Liquid electrolyte | 189 | — |
| Comp. Ex. 3 | 1.1 | Liquid electrolyte | 185 | — |
| Comp. Ex. 4 | 0 | Sulfide solid | 173 | 198 |
| | | electrolyte | | |
| Example 1 | 0.4 | Sulfide solid | 179 | 203 |
| | | electrolyte | | |
| Example 2 | 0.6 | Sulfide solid | 183 | 206 |
| | | electrolyte | | |
| Example 3 | 1.1 | Sulfide solid | 188 | 210 |
| | | electrolyte | | |

As shown in Table 1 and FIG. 3, the capacity decreased as the Nb substituted amount increased in the liquid batteries (Comparative Examples 1 to 3). Meanwhile, in the all solid state batteries (Examples 1 to 3 and Comparative Example 4), the capacity increased as the Nb substituted amount increased, surprisingly. The reason therefor is presumed that, when Nb exists in the cathode active material of an all solid state battery, Nb was diffused into the cathode active material surface, and the diffused Nb functions as a pseudo LiNbO₃ layer (coating layer), together with nearby existing Li and O, so that the reaction between the cathode active material and the sulfide solid electrolyte was suppressed.

### REFERENCE SIGNS LIST

1 . . . cathode layer
2 . . . anode layer
3 . . . solid electrolyte layer
4 . . . cathode current collector
5 . . . anode current collector
6 . . . battery case
10 . . . all solid state battery
11 . . . cathode active material
12 . . . coating layer
20 . . . composite cathode active material

What is claimed is:

1. An all solid state battery comprising a cathode layer including a composite cathode active material, an anode layer, and a solid electrolyte layer formed between the cathode layer and the anode layer,
wherein the composite cathode active material includes a cathode active material represented by LiₐNiₓCo_{y}Al_{z}Nb_{b}O₂ wherein 1.0≤a≤1.05, x+y+z+b=1, 0.8≤x≤0.83, 0.13≤y≤0.15, 0.03≤z≤0.04, 0<b≤0.011; and a coating layer covering at least a part of a surface of the cathode active material and including an ion conductive oxide, and
wherein at least one of the cathode layer and the solid electrolyte layer includes a sulfide solid electrolyte.

2. The all solid state battery according to claim 1, wherein the “b” satisfies 0.004≤b≤0.011.

3. The all solid state battery according to claim 1, wherein the “b” satisfies 0.006≤b≤0.011.

4. The all solid state battery according to claim 1, wherein the ion conductive oxide is LiNbO₃.
